(19) United States
(12) Patent Application Publication
(10) Pub. No.: US 2026/0133161 A1
(43) Pub. Date: May 14, 2026

(54) ELECTROPHORESIS DEVICE, MICRO-COIL FIBER, SWEEPING THERMAL-DRAWING DEVICE, METHOD OF MANUFACTURING FIBER, AND FIBER

(71) Applicant: TOHOKU UNIVERSITY, Miyagi (JP)

(72) Inventors: YUANYUAN GUO, Miyagi (JP); ETIENNE LE BOURDONNEC, Miyagi (JP); SORA KARIMATA, Miyagi (JP); SHUNSUKE KATO, Miyagi (JP)

(73) Assignee: TOHOKU UNIVERSITY, Miyagi (JP)

(21) Appl. No.: 19/389,017

(22) Filed: Nov. 14, 2025

(30) Foreign Application Priority Data
Nov. 14, 2024 (JP) 2024-198881

(51) Int. Cl. G01N 27/447; B29C 55/22; B29K 21/00; B29K 101/12; B29L 23/00

(52) U.S. Cl. CPC G01N 27/44791; B29C 55/22; G01N 27/44704; B29K 2021/003; B29K 2101/12; B29L 2023/22

(57) ABSTRACT

An electrophoresis device is provided. The device may include a tube having an introduction port for a sample, formed therein, the tube having an inner diameter of 100 μm or less, at least two spiral electrodes provided in the tube, and a power supply device that applies a voltage to the spiral electrodes.

### TECHNICAL FIELD

The present disclosure relates to an electrophoresis device, a micro-coil fiber, a sweeping thermal-drawing device, a method of manufacturing a fiber, and a fiber.

### BACKGROUND OF THE DISCLOSURE

Non-Patent Literature 1 discloses silicone-based highly stretchable fiber pumps. Non-Patent Literature 1 discloses that helical conductor wires are provided in a silicone tube. An electric field is generated in the tube by applying a voltage to the conductor wires to cause a fluid to flow in one direction.

Non-Patent Literature 2 discloses fiber pumps for wearable fluidic systems. In Non-Patent Literature 2, copper electrode wires are provided in a polyurethane tube, and the polyurethane tube is wound around a shaft to make the conductive wire electrodes helical. After that, the shaft is removed from the tube so that a region where the shaft has been present is provided as a flow channel of a fluid.

A technology for handling and applying fluids in a microliter scale called a microfluidics technology is used in a wide range of fields such as life sciences, chemistry, and materials engineering. For example, a technology for mixing or separating cells or particles also belongs to this microfluidics technology.
Non-Patent Literature 1: Ryo Kanno, Keita Shimizu, Kazuya Murakami, Yuya Shibahara, Naoki Ogawa, Hideko Akai & Jun Shintake: Scientific Reports (2024) 14:4618
Non-Patent Literature 2: Michael Smith, Vito Cacucciolo, Herbert Shea: Science 379, 1327-1332 (2023) 31 Mar. 2023

### SUMMARY

Many conventional microfluidic devices are produced by using a lithography method, which is a semiconductor manufacturing technology, on a planar substrate. In this case, there are problems such as restrictions on material selection, complexity of a manufacturing process, and limitation to a planar structure. Not only in this microfluidic device field but also in manufacture of, for example, an electrophoresis device and a minute coil, there has been a demand to achieve a structure that has been previously impossible, by means of new methods.

Some examples described herein may address the above-described problems. Some examples described herein may provide a new electrophoresis device, micro-coil fiber, sweeping thermal-drawing device, method of manufacturing a fiber, and fiber.

In some examples, an electrophoresis device includes a tube having an introduction port for a sample, formed therein, the tube having an inner diameter of 100 μm or less, at least two spiral electrodes provided in the tube, and a power supply device that applies a voltage to the spiral electrodes.

Other features of the present disclosure are made clear in the following.

### BRIEF DESCRIPTION OF DRAWINGS

FIG. 1 is a sectional view of an electrophoresis device.

FIG. 2A is a transverse sectional view illustrating a mold and a first film.

FIG. 2B is a vertical sectional view illustrating the mold and the first film.

FIG. 3A shows grooves.

FIG. 3B shows conductive wires stored in the grooves, and a second film.

FIG. 3C is a sectional view of the actually-created preform.

FIG. 4A is a view illustrating an overall view of the rotation thermal-drawing device.

FIG. 4B is an enlarged view of the broken-line portion of FIG. 4A.

FIG. 5 is a photograph of a fiber subjected to thermal drawing by the rotation thermal-drawing device.

FIG. 6 is a photograph of a cross section of the fiber of FIG. 5.

FIG. 7 is a perspective view of a micro-coil fiber.

FIG. 8 is a sectional view of the micro-coil fiber of FIG. 7.

FIG. 9 illustrates modification examples of the micro-coil fiber.

FIG. 10A shows a micro-coil fiber including four coils at least a part of which is covered with the tube.

FIG. 10B is a sectional view of a micro-coil fiber having magnetic particles.

FIG. 10C is a sectional view of a micro-coil fiber including a porous material and magnetic particles.

FIG. 11 is a sectional view illustrating another modification example of the micro-coil fiber.

FIG. 12A shows a base made of a thermoplastic polymer or thermoplastic elastomer material.

FIG. 12B shows that four conductor wires are respectively inserted in the four holes.

FIG. 12C is a sectional view of FIG. 12B.

FIG. 13A is a view illustrating that the preform exemplified in FIGS. 12A to 12C is processed by the rotation thermal-drawing device.

FIG. 13B is a view illustrating a method of manufacturing a micro-coil fiber including the bar magnet.

FIG. 14 is a perspective view of a sweeping thermal-drawing device.

FIG. 15 is an enlarged view of the first supply device and a gear part.

FIG. 16 is an enlarged view of the vicinity of the second supply device and the heating tube.

FIG. 17 shows a configuration example of a sweeping thermal-drawing device.

FIG. 18A is a view showing a zigzag portion that is symmetrical in a side view.

FIG. 18B is a view showing a zigzag portion that is asymmetrical in a side view.

FIG. 19 is a photograph of the created device.

FIG. 20 is a photograph of a fiber having a sample introduced therein.

FIG. 21 is a photograph illustrating an exemplary micro-coil fiber fabrication.

FIG. 22 is a photograph illustrating another exemplary micro-coil fiber fabrication.

FIG. 23 is a view illustrating an example of a method of manufacturing a fiber.

FIG. 24 is a view illustrating an example of a sectional view of the fiber.

FIG. 25A is a view illustrating a creation example of the preform.

FIG. 25B is a sectional photograph of the actually manufactured preform.

FIG. 25C is a view illustrating an example of a fiber.

FIG. 26 is a photograph of an actually manufactured fiber.

FIG. 27 is a photograph showing results of an electrophoresis experiment.

FIG. 28 is a photograph showing results of an electrophoresis experiment.

FIG. 29 is a graph summarizing magnetic fields generated by various micro-coil fibers.

FIG. 30 is a diagram illustrating a magnetic field strength per unit current.

FIG. 31 is a diagram illustrating a relationship between a hollow occupancy rate of the bar magnet and the magnetic field strength per unit current in the micro-coil fiber.

FIG. 32 is a plan view of the manufactured micro-coil fiber.

FIG. 33 is a sectional view of the micro-coil fiber of FIG. 32.

FIG. 34 is a view illustrating an example of an arrangement of a plurality of micro-coil fibers.

FIG. 35 is a diagram illustrating the V-shaped micro-coil fibers and magnetic field lines generated thereby.

FIG. 36A illustrates an example in which a magnetic field at a predetermined position is adjusted with four micro-coil fibers.

FIG. 36B is a diagram of the same configuration as FIG. 36A as viewed from a different angle.

FIG. 37 shows the relationship between the magnetic stimulation and the cellular activity.

FIG. 38 illustrates the influence caused by the magnetic stimulation to the neural activity.

FIG. 39 is statistical data of the experiment performed with respect to the synchronized nerve cells.

FIG. 40 shows the relationship between the magnetic stimulation and the cellular activity.

FIG. 41 illustrates the influence caused by the magnetic stimulation to the neural activity.

FIG. 42 is statistical data of an experiment with respect to the spontaneously active nerve cells.

FIG. 43 is a view illustrating a part of a sweeping thermal-drawing device.

FIG. 44 shows six photographs of three fibers.

It will be appreciated that elements in the figures are illustrated for simplicity and clarity and have not necessarily been drawn to scale. For example, the dimensions of some of the elements in the figures may be exaggerated relative to other elements to help understanding of illustrated embodiments of the present disclosure.

### DETAILED DESCRIPTION OF EXEMPLARY EMBODIMENTS

### First Embodiment

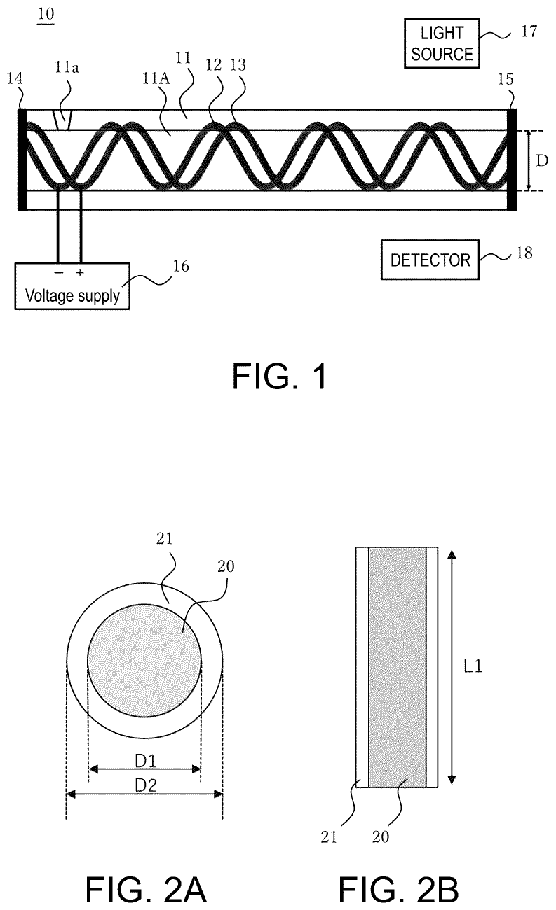

FIG. 1 is a sectional view of an electrophoresis device according to an embodiment. This electrophoresis device 10 includes a tube 11 functioning as a capillary. According to one example, the tube 11 has an inner diameter D of 200 μm or less. According to another example, the inner diameter D is 50 μm or less. An introduction port 11a for putting a sample into the tube 11 is formed in the tube 11. The material of the tube 11 is not particularly limited, and the material may be, for example, a thermoplastic polymer or a thermoplastic elastomer. Examples of the thermoplastic polymer include polycarbonate, PMMA, and COC, and examples of the thermoplastic elastomer include PU, SEBS, COCe, SBS, and SIS.

The tube 11 has a microchannel 11A therein. With lids 14 and 15 that close both ends of the tube 11, the microchannel 11A becomes a sealed space elongated in a lateral direction. At least two spiral electrodes are provided in the tube 11. FIG. 1 shows that spiral electrodes 12 and 13 are provided in the tube 11 while maintaining a non-contact state and causing center axes thereof to match each other. The spiral electrodes 12 and 13 may be exposed to an inner wall of the tube 11, or a part or the whole thereof may be embedded in the tube 11. According to one example, at least a part of the spiral electrodes 12 and 13 is provided in the microchannel 11A, and hence the spiral electrodes 12 and 13 may be in contact with a reagent. In this case, as the material of the spiral electrodes 12 and 13, a material that can reduce deterioration or corrosion in liquid is selected. For example, a carbon composite material or a material containing a carbon composite material is selected for the material of the spiral electrodes 12 and 13 to reduce deterioration or corrosion of the spiral electrodes. According to another example, chemically inert conductor is selected for the material of the spiral electrodes 12 and 13.

This electrophoresis device 10 includes a power supply device 16 that applies a voltage to the spiral electrodes 12 and 13. The power supply device 16 can apply a voltage to the spiral electrodes 12 and 13. Outside of the tube 11, a light source 17 and a detector 18 are provided. According to one example, the light source 17 and the detector 18 perform ultraviolet-visible absorption spectroscopy (UV-Vis) at a specific position of the microchannel 11A. The light source 17 irradiates a sample in the microchannel 11A with light ranging from the ultraviolet to visible regions. The detector 18 acquires a spectrum by detecting light transmitted through or reflected by the sample. In the case of reflection, the detector 18 is provided at a position close to the light source 17. This makes it possible to analyze chemical characteristics such as substance, concentration, electron state, and three-dimensional structure of the sample. According to another example, a light source having a different wavelength range can be used. As for details of an optical system and measurement, publicly-known methods can be used, and hence description thereof is omitted.

As a comparative example, a conventional capillary electrophoresis device is described. In the conventional-type capillary electrophoresis device, in a state in which both ends of the capillary are immersed in two beakers each including an electrolytic solution, a high voltage is applied to the electrolytic solution. This allows the sample in the capillary to move at a speed corresponding to a sum of electrophoresis and electroosmotic flow, and allows separation of sample components to be achieved. In the capillary electrophoresis device of the comparative example, two beakers and a high-voltage power supply are required, and hence the device tends to be increased in size.

In contrast, the capillary electrophoresis device according to the embodiment is the same as the comparative example in that the sample in the capillary moves at a speed corresponding to a sum of electrophoresis and electroosmotic flow, and separation of sample components is achieved, but the sample is subjected to electrophoresis by applying a voltage to the spiral electrodes 12 and 13 formed integrally with the tube 11. That is, an electric field is generated in the microchannel 11A by the spiral electrodes 12 and 13 to which a voltage is applied, and each component of the sample is subjected to electrophoresis by this electric field. With the electrophoresis being caused by the spiral electrodes 12 and 13 as described above, beakers and a high voltage as used in the comparative example can be omitted. Thus, it is possible to say that the electrophoresis device according to the embodiment is suitable for downsizing.

Next, a method of manufacturing a fiber according to a first embodiment is described. This manufacturing method includes forming a preform including a conductive wire and a base material, and forming a fiber by subjecting the preform to thermal drawing in one direction while rotating the preform. The preform refers to a semi-finished product before thermal drawing obtained by combining, processing, or shaping constituent materials of the fiber to become a state that allows thermal drawing. The fiber refers to a product after being subjected to thermal drawing.

### 1. Formation Example of Preform

First, a first film that becomes a material of a tube is wound around a cylindrical mold. FIG. 2A is a transverse sectional view illustrating a mold 20 and a first film 21 wound and fixed around the mold 20. The first film 21 is, for example, a thermoplastic polymer or a thermoplastic elastomer. In this example, as the first film 21, a PMMA film is wound around the cylindrical mold 20. According to one example, the mold 20 has a diameter D1 of 15 mm, and a diameter D2 of an integrated product of the mold 20 and the first film 21 is 19 mm. FIG. 2B is a vertical sectional view illustrating the mold 20 and the first film 21 wound and fixed around the mold 20. In this example, a length L1 of the integrated product of the mold 20 and the first film 21 is 150 mm. According to one example, after the first film 21 is wound around the mold 20 as described above, each of the front and the back of the first film 21 is heated at 175° C. for 8 minutes, and the first film 21 is heated for 16 minutes in total, thereby pressure-bonding the first film 21 to the mold 20. The front and the back of the first film 21 refer to two different side surfaces of the first film 21. According to another example, any heating method of heating a plurality of portions of the first film 21 can be adopted.

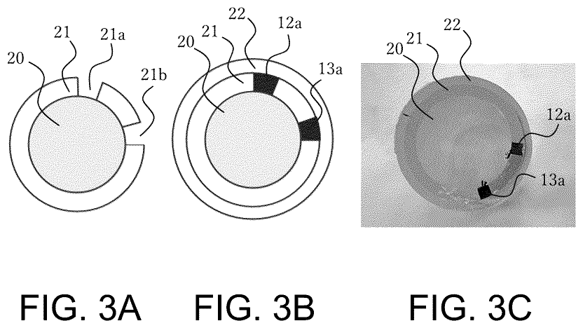

After the pressure-bonding, a groove is formed in the first film 21 by, for example, a CNC lathe or the like. FIG. 3A shows that grooves 21a and 21b are formed in the first film 21. The grooves 21a and 21b are formed to store electrodes. The groove may pass through the first film 21 or may be a dent of the first film 21. In the two grooves 21a and 21b, for example, conductive wires (electrodes) of a carbon composite material are respectively stored. Next, a second film is wound and fixed around the first film 21 and the conductive wires. FIG. 3B shows conductive wires 12a and 13a stored in the grooves, and a second film 22. FIG. 3C is a sectional view of the actually-created preform. The diameter of the preform of FIG. 3C is 22 mm, and a sectional size of each of the conductive wires 12a and 13a is 2×2 mm. The grooves 21a and 21b can each be formed at any position of the first film 21. Adjustment of a distance between the groove 21a and the groove 21b allows the distance between the two conductive wires stored therein to be freely designed. For example, the distance between the two conductive wires can be reduced by forming the two grooves in an arc part having a center angle of 90° in a circumference of the first film 21 in sectional view. According to another example, the distance between the two conductive wires can be increased by forming one groove in the arc part having the center angle of 90° in the circumference of the first film 21 in sectional view, and forming another groove in another arc part having a center angle of 90°. Moreover, with the number of grooves being increased or decreased, the number of conductive wires to be stored therein can be increased or decreased. For example, when three grooves are formed in the first film 21 and one conductive wire is provided in each of the grooves, with rotation thermal-drawing treatment to be described later being performed, a fiber including three spiral electrodes can be manufactured. The number of grooves and the number of conductive wires can be freely adjusted.

Next, the second film 22 is heated so that the second film 22 is pressure-bonded to the first film 21 and the conductive wires 12a and 13a. In this heating, each of the front and the back of the second film 22 is heated by, for example, 175° C. for 8 minutes, and thus the second film 22 is heated for 16 minutes in total. According to another example, any heating method of heating a plurality of portions of the second film 22 can be adopted.

Next, the mold 20 is removed from the first film 21. In this manner, a preform including the first film 21 and the second film 22 as the base material and including the conductive wires 12a and 12b as the electrode material is formed. According to another example, the preform can be formed by another method. Any process capable of forming a bar-shaped preform by integrating the base material and the conductive wires can be adopted.

### 2. Formation Example of Fiber

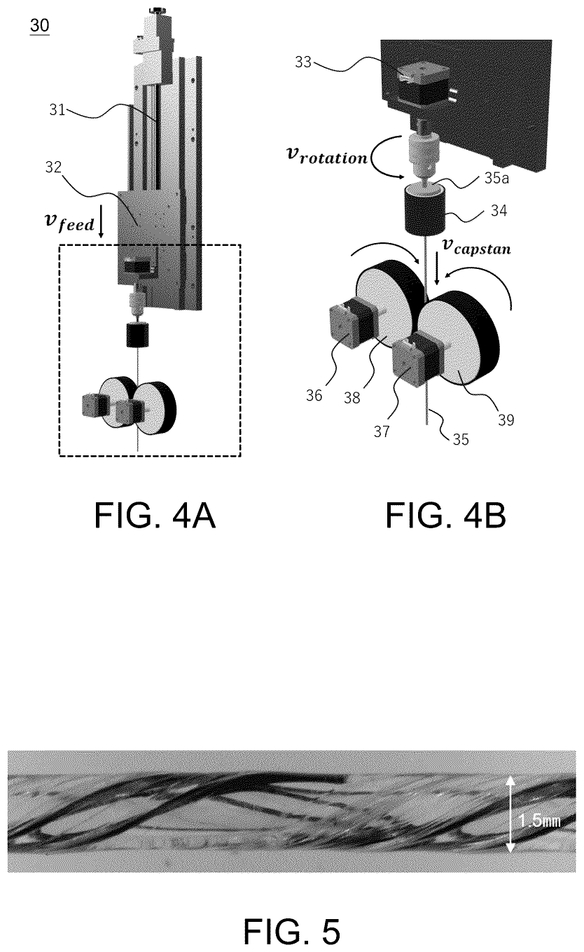

The above-mentioned fiber is subjected to thermal-drawing treatment by a rotation thermal-drawing device. FIGS. 4A and 4B are views illustrating a configuration example of the rotation thermal-drawing device. FIG. 4A is a view illustrating an overall view of the rotation thermal-drawing device. This rotation thermal-drawing device 30 includes a linear guide 31. The linear guide 31 can feed a stage 32 straight downward at a speed of v_{feed}. FIG. 4B is an enlarged view of the broken-line portion of FIG. 4A. FIG. 4B shows that the preform can be rotated by a stepping motor 33. According to one example, a heater 34 is shaped to surround a preform 35a, and this makes it possible to heat the entire preform 35a. Moreover, rotations of rollers 38 and 39 are respectively controlled by stepping motors 36 and 37. The preform 35a is rotated by the stepping motor 33 at a rotation speed of vᵣₒₜₐₜᵢₒₙ, and simultaneously receives a tensile force in the vertical direction by the rotations of the rollers 38 and 39. This allows a fiber 35 subjected to rotation thermal-drawing to be obtained. A pitch of the spiral electrodes can be adjusted as the following expression.

$$pitch = {v}_{capstan} / {v}_{rotation}$$

Here, v_{capstan} represents a downward feed speed of the preform 35a given by the rotations of the rollers 38 and 39, and vᵣₒₜₐₜᵢₒₙ represents a rotation speed of the preform. A diameter (D_{fiber}) of the fiber 35 is represented by the following expression.

$${D}_{fiber} = {D}_{perform} \times \sqrt{\frac{{v}_{capstan}}{{v}_{feed}}} \qquad [ Math . 1 ]$$

Here, D_{preform} represents a diameter of the preform 35a. As described above, with the use of this rotation thermal-drawing device, the pitch of the spiral electrodes and the diameter of the spiral electrode can be freely adjusted.

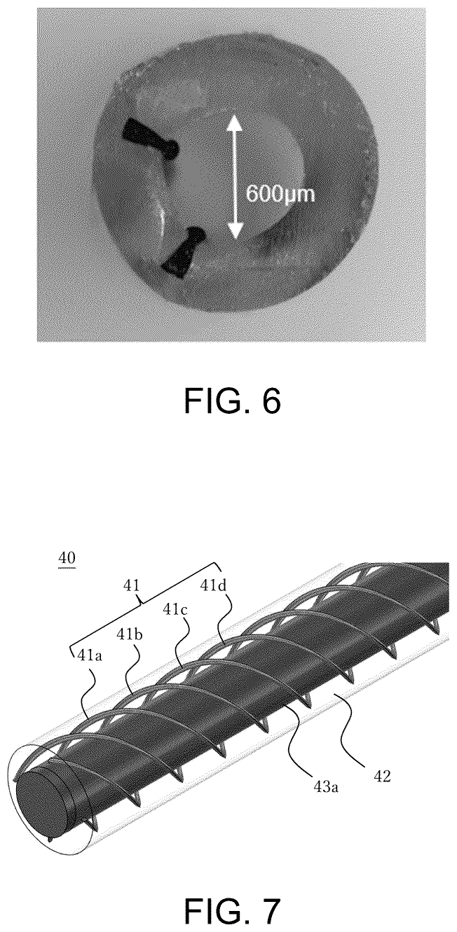

According to one example, the fiber can be formed by, after heating the preform by the heater at 230° C. for 20 minutes, drawing the preform while rotating the preform. FIG. 5 is a photograph of a fiber subjected to thermal drawing by the rotation thermal-drawing device. FIG. 5 shows that a fiber having a diameter of 1.5 mm includes two spiral electrodes. FIG. 6 is a photograph of a cross section of the fiber of FIG. 5. FIG. 6 shows an annular tube in which a microchannel having a diameter of 600 μm is formed at a middle of the tube. Moreover, FIG. 6 also shows that two spiral electrodes are formed.

After the fiber is formed, an introduction port for putting a reagent into the tube is formed, lids are attached to both ends of the tube, and wiring lines for voltage application are connected to the spiral electrodes exposed by machining the tube. In this manner, the electrophoresis device of FIG. 1 can be manufactured.

According to another example, the rotation thermal-drawing device may adopt another configuration. That is, the rotation thermal-drawing device can have any device configuration including a feeding system that feeds the preform while rotating the preform, a heating device that heats the preform, and a drawing device that uniaxially draws the preform heated by the heating device.

### Second Embodiment

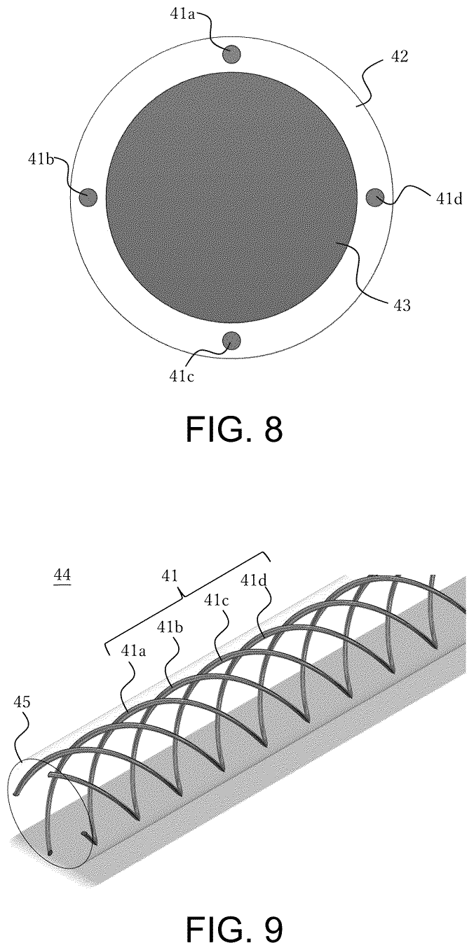

FIG. 7 is a perspective view of a micro-coil fiber. This micro-coil fiber 40 includes one micro-coil 41 obtained by combining a plurality of coils having the same pitch and each having an inner diameter of 500 μm or less. According to one example, the micro-coil 41 is embedded in a tube 42. In the example of FIG. 7, the micro-coil 41 includes four coils 41a, 41b, 41c, and 41d. According to another example, the number of coils can be three or less or five or more. At the center of the micro-coil 41, that is, in a hollow part of the tube 42, a bar magnet 43 is provided. With the bar magnet 43 being provided, a magnetic permeability of the fiber can be enhanced, and hence a stronger magnetic field can be generated. FIG. 8 is a sectional view of the micro-coil fiber of FIG. 7. FIG. 8 shows that the coils 41a, 41b, 41c, and 41d are provided at substantially equal intervals along the annular tube 42.

According to one example, this micro-coil fiber 40 can be used for non-invasive brain stimulation called trans-cranial static magnetic stimulation, or can be implanted in the cortex for a similar purpose. Forming the inner diameter of the coil to 500 μm or less allows such stimulation to be locally applied. Moreover, increasing the number of coils contributes to provision of a sufficiently strong magnetic field. Thus, with the use of the micro-coil fiber 40, a sufficiently strong magnetic field can be locally applied.

According to another example, this micro-coil fiber 40 can be used as a magnetic sensing device. Non-invasive measuring technologies for measuring brain functions, such as electroencephalography (EEG), magnetoencephalography (MEG), functional magnetic resonance imaging (fMRI), and functional near-infrared spectroscopy (fNIRS), are used for the diagnosis of brain disorders. The micro-coil fiber 40 can be used for those measurements. The micro-coil fiber and a magnetic sensor are required for such usage.

According to another example, this micro-coil fiber 40 can be adopted to a next-generation compact nuclear magnetic resonance (NMR) system. This makes it possible to locally excite the sample and detect a signal.

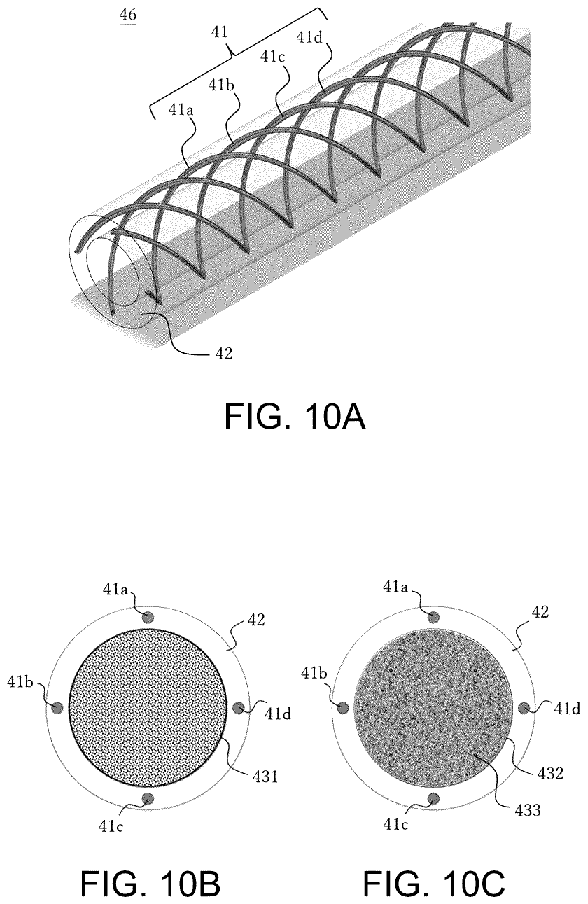

FIGS. 9 to 10C are views illustrating modification examples of the micro-coil fiber. According to one example, the micro-coils 41 of FIGS. 9 to 10C can have the same dimension and the same shape as the micro-coil of FIGS. 7 and 8. FIG. 9 shows a rod-type micro-coil fiber 44. The rod type means that, for example, a base of a thermoplastic polymer or a thermoplastic elastomer is formed in a bar shape without including a hole for storing a bar magnet. FIG. 9 shows that the micro-coil 41 including four coils is embedded and formed in a bar-shaped base 45 having no hole. FIG. 10A shows a micro-coil fiber 46 including four coils 41a, 41b, 41c, and 41d at least a part of which is covered with the tube 42. In the example of FIG. 10A, no bar magnet is provided and a flow channel part of the tube 42 is hollow. FIG. 10B is a sectional view of a micro-coil fiber having magnetic particles 431 provided in this hollow part. The magnetic particles 431 are, for example, iron microbeads, but the magnetic particles 431 are not limited thereto, and various materials having magnetic properties correspond thereto. When a magnetic field is applied by the micro-coil 41, the mobility of the magnetic particles 431 provided in the flow channel of the tube 42 can be controlled.

FIG. 10C is a sectional view of a micro-coil fiber including a porous material and magnetic particles in the hollow part of the tube. A porous material 432 is formed in the flow channel of the tube 42. The porous material 432 is a porous polymer according to one example. When a water-absorbed polymer is provided in the tube of the preform and the preform is subjected to thermal-drawing treatment, water evaporates and the polymer changes its shape to form porous holes. Additionally, phase separation of the solution can occur during the thermal drawing, which produces porous materials in the center. That is, a porous polymer can be formed in the flow channel of the tube. With temperature conditions in thermal drawing being controlled, the size and amount of pores of the porous material can be adjusted. It is to be noted that water is removed to prevent the polymer material other than the polymer provided in the tube from becoming porous in thermal drawing.

Then, magnetic particles 433 are provided in the pores of the porous material 432. Each of a large number of magnetic particles 433 is a magnet, and contributes to enhancement of a magnetic field to be generated. The magnetic particles can be provided to be present in the entire porous material 432. For example, when the magnetic particles are provided to the porous material exposed from an end portion of the tube, since the pores of the porous material 432 are connected in a longitudinal direction of the tube, the minute magnetic particles 433 enter the fiber by the capillary effect. Thus, a state in which the magnetic particles 433 are held in the porous material 432 and are present in a certain density is maintained.

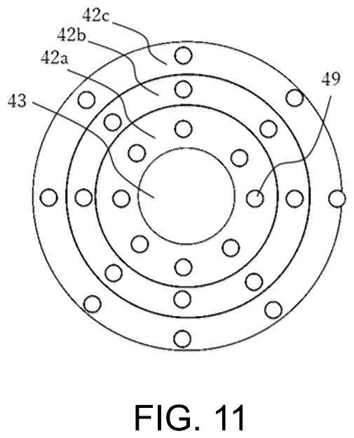

FIG. 11 is a sectional view illustrating another modification example of the micro-coil fiber. Three tubes 42a, 42b, and 42c are formed to overlap concentrically. A bar magnet 43 is provided at the middle of the three tubes 42a, 42b, and 42c. Seven coils 49 are formed in the tube 42a, eight coils 49 are formed in the tube 42b, and eight coils 49 are formed in the tube 42c. According to another example, the number of tubes and the number of coils can be increased or decreased. As a method of manufacturing such a micro-fiber, for example, a series of works of winding and fixing a film around a mold, forming a groove in this film, and putting a conductive wire in the groove is repeated a plurality of times to form a preform. After that, the mold is removed, and the preform is subjected to rotation thermal-drawing treatment, thereby being capable of manufacturing a micro-coil fiber including a large number of coils as illustrated in FIG. 11. According to another example, a micro-coil fiber as illustrated in FIG. 11 can be manufactured even by forming, in a cylindrical base material, a hole for storing a bar magnet and a hole for storing a coil, putting a conductive wire into the hole for storing the coil, and performing rotation thermal-drawing treatment. A micro-coil fiber including coils provided in a multi-layered manner as described above can be regarded as a micro-coil fiber obtained by adding the following two to the micro-coil fiber illustrated in FIGS. 7 and 8.
Additional tube covering an outer rim of the tube
One additional micro-coil obtained by combining a plurality of coils having the same pitch and having at least a part embedded in the additional tube

A method of manufacturing a micro-coil fiber is described. The micro-coil fiber can be manufactured by forming a preform and subjecting the preform to thermal drawing in one direction while rotating the preform with the use of the above-mentioned rotation thermal-drawing device. Hereinafter, the method of manufacturing a rod-type micro-coil fiber is described, but the micro-coil fibers of FIGS. 7 and 10A to 10C can also be manufactured by the same method.

### 1. Formation Example of Preform

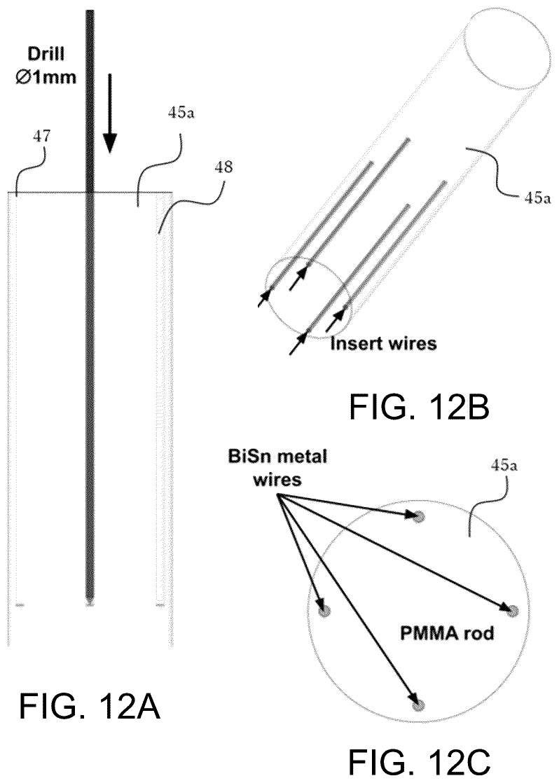

FIGS. 12A to 12C are explanatory views illustrating a method of forming a preform. FIG. 12A shows a base 45a made of, for example, a thermoplastic polymer or thermoplastic elastomer material. For example, an elongated hole having a diameter of 1 mm is formed in this base 45a with a drill. FIG. 12A shows holes 47 and 48 formed with the drill and a new hole being formed in the base 45a with the drill. Next, a conductor wire is inserted in the hole formed in the base. FIG. 12B shows that four conductor wires are respectively inserted in the four holes. Those conductor wires become four coils by rotation drawing as described later. FIG. 12C is a sectional view of FIG. 12B. FIG. 12C shows that PMMA can be adopted as an example of the material of the bar-shaped base, and BiSn can be adopted as an example of the conductor wire. According to one example, a plurality of conductor wires can be provided substantially at equal intervals along the outer rim of the base.

### 2. Formation Example of Fiber

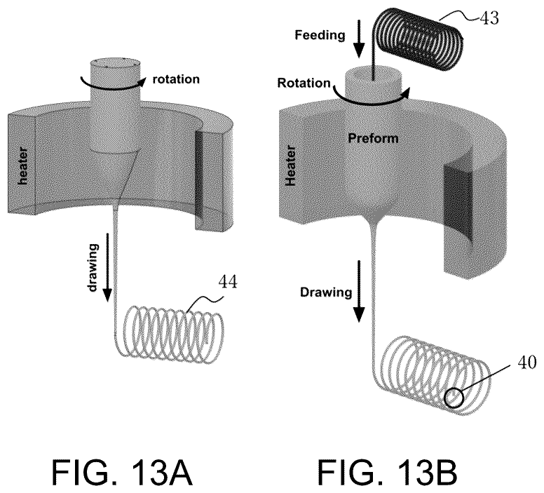

The micro-coil fiber can be formed by drawing the preform while rotating the preform with the use of the above-mentioned rotation thermal-drawing device. FIG. 13A is a view illustrating that the preform exemplified in FIGS. 12A to 12C is processed by the rotation thermal-drawing device. After the rotation thermal-drawing is ended, the micro-coil fiber 44 of FIG. 9 is obtained. FIG. 13B is a view illustrating a method of manufacturing a micro-coil fiber including the bar magnet 43. As illustrated in this figure, the preform can be subjected to rotation thermal-drawing treatment while supplying the bar magnet 43 into the hole at the middle of the preform. This makes it possible to create the micro-coil fiber 40 of FIG. 7. By means of rotation thermal-drawing, a plurality of metal coils can be rotated and drawn at the same time, and the number of coils can be any number. As the number of coils is increased, a stronger magnetic field can be generated. It is to be noted that not only this fiber but also all fibers to be described later can be manufactured with the use of the rotation thermal-drawing device of FIG. 4A.

The magnetic field of the manufactured micro-coil fiber was obtained by theoretical calculation. When a current of 50 mA was caused to flow through a micro-coil fiber manufactured by storing four coils in the base and performing rotation thermal-drawing at 150 rpm, a magnetic flux density was 131 μT. When a current of 50 mA was caused to flow through a micro-coil fiber manufactured by storing eight coils in the base and performing rotation thermal-drawing at 120 rpm, a magnetic flux density was 215 μT. A micro-coil fiber including the bar magnet 43 of FIG. 7 had a magnetic flux density of 1 T.

### Third Embodiment

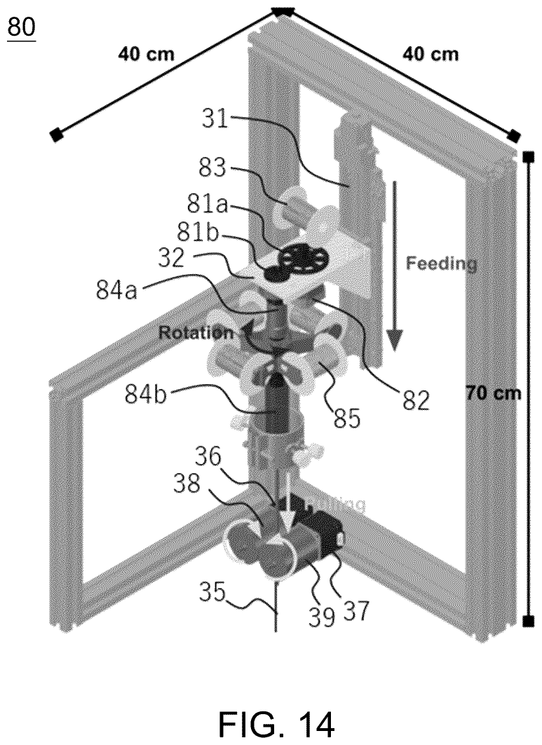

FIG. 14 is a perspective view of a sweeping thermal-drawing device 80. The sweeping thermal-drawing device 80 (hereinafter sometimes referred to as an S-type thermal-drawing device 80) is obtained by modifying the above-mentioned rotation thermal-drawing device 30. In the S-type thermal-drawing device 80, the same components as respective ones of or components corresponding to respective ones of the rotation thermal-drawing device 30 are denoted by reference symbols used in the description of the rotation thermal-drawing device 30, and repetitive description thereof may be omitted. According to one example, the S-type thermal-drawing device 80 includes, on the stage 32, a first gear 81a and a second gear 81b. The first gear 81a is subjected to any rotation by a motor 82. The second gear 81b meshes with the first gear 81a, and the rotation of the first gear 81a causes the second gear 81b to rotate. According to one example, the first gear 81a has a diameter larger than that of the second gear 81b.

Below the second gear 81b, a rotation tube 84a and a heating tube 84b are provided. The rotation tube 84a holds and fixes a part of the completed or uncompleted preform in the drawing direction. Moreover, this rotation tube 84a rotates in conjunction with the rotation of the second gear 81b to rotate the preform. Thus, in the rotation tube 84a, the preform is fixed in the drawing direction and rotated in any rotation pattern in the rotation direction. According to one example, the rotation of the second gear 81b causes the preform to rotate via the rotation tube 84a. With the motor 82 being controlled, the preform can be subjected to any rotation. For example, the rotation speed can be increased or decreased. That is, the rotation speed can be varied. Regarding rotation in one direction, unidirectional constant-speed rotation and unidirectional non-uniform rotation are allowed. Moreover, the rotation direction can be freely changed. For example, rotation in a first direction and rotation in a second direction opposite to the first direction can be repeated, or a rotation speed in the first direction and a rotation speed in the second direction can be different. As described above, it is possible to manufacture a fiber having a new shape by rotating the preform at a non-uniform velocity or reciprocating the preform in the rotation direction.

The heating tube 84b is a part that stores a heater for heating the preform therein. According to one example, the heater in the heating tube 84b can be shaped to surround the preform as the heater 34 of FIG. 4B. The heating tube 84b can have any configuration capable of performing heating treatment.

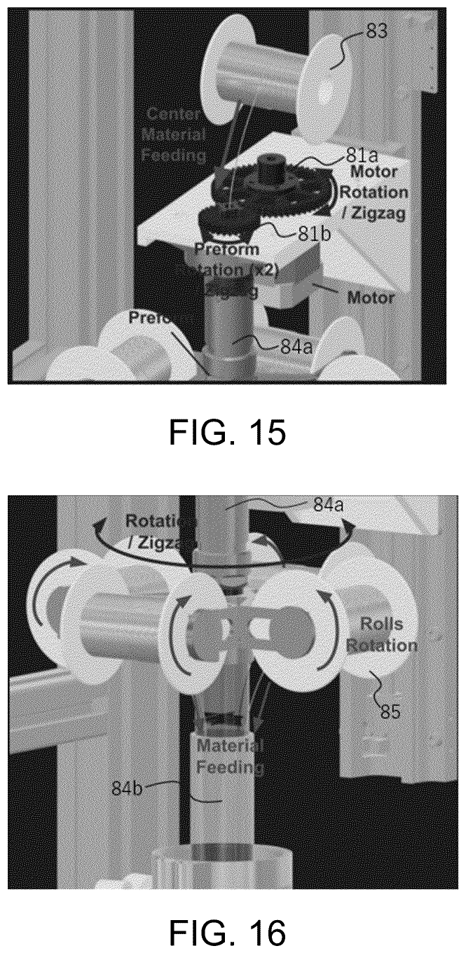

FIG. 14 shows a first supply device 83 that is a supply device of a center material. The center material refers to a material to be supplied to the hollow in a shaft part of the preform. The center material is a bar magnet to be provided in the hollow part of the preform according to one example. FIG. 15 is an enlarged view of the first supply device 83 and a gear part. A through hole is formed at, for example, the middle of the second gear 81b. The through hole of the second gear 81b is a hole communicating with the inside of the rotation tube 84a. The center material wound and stored in the first supply device 83 is caused to pass through this through hole to be provided in the shaft part of the preform in the rotation tube 84a. In order to facilitate this, the second gear 81b may be provided directly above the rotation tube 84a. With the preform including the center material being subjected to heat treatment while receiving a downward tensile force, a fiber including a base and a center material can be manufactured. It is to be noted that, in the rotation thermal-drawing device 30 of FIG. 4A, the preform is directly rotated by the stepping motor 33, and hence the center material cannot be supplied to the preform.

The center material may be a solid such as a wire, a liquid, or a gas. FIG. 14 shows the first supply device 83 that provides the bar magnet, that is, a solid as the center material, but the first supply device can be a liquid providing device or a gas providing device.

FIG. 14 shows a second supply device 85 that is a supply device of a non-center material. The non-center material is a material to be provided on the outer rim side of the preform. The non-center material is, for example, a material of an electrode to be provided along the outer rim of the base, such as a spiral electrode. FIG. 16 is an enlarged view of the vicinity of the second supply device 85 and the heating tube 84b. FIG. 16 shows that four second supply devices 85 are provided around the rotation tube 84a. It is also possible to provide the second supply devices around the heating tube 84b. The non-center material wound and stored in the second supply device 85 is provided to the outer rim side of the preform. According to another example, it is possible to perform work in advance to form, in the preform, a hole extending in the longitudinal direction of the preform, and provide the non-center material to this hole from the second supply device 85. According to further another example, the non-center material may be manually provided in the hole of the preform, and provision of the non-center material by the second supply device 85 may be omitted. With the preform including the non-center material being subjected to heat treatment while receiving a downward tensile force, a fiber including a base and a non-center material can be manufactured.

The non-center material may be a solid such as a wire, a liquid, or a gas. FIG. 16 shows the second supply device 85 that provides the electrode material, that is, a solid as the non-center material, but the second supply device can be a liquid providing device or a gas providing device.

The rotations of the rollers 38 and 39 are respectively controlled by the stepping motors 36 and 37 illustrated in FIG. 14. According to one example, with the rotations of the rollers 38 and 39, all of the preform, the center material, and the non-center material are drawn in the vertical direction to manufacture the fiber 35. Depending on the type of the fiber to be manufactured, no center material may be provided or no non-center material may be provided. Moreover, with the center material being inserted in the preform in advance, it is possible to not use the first supply device 83, and, with the non-center material being inserted in the preform in advance, it is possible to not use the second supply device 85. In this case, in addition to this vertical-direction drawing, as described above, a motion in any rotation direction can be given to the preform by the rotation of the second gear 81b.

The second gear 81b, the rotation tube 84a, the heating tube 84b, and the rollers 38 and 39 are arranged on one straight line in the vertical direction. This makes it possible to provide the center material or provide the non-center material while moving the preform in the rotation direction.

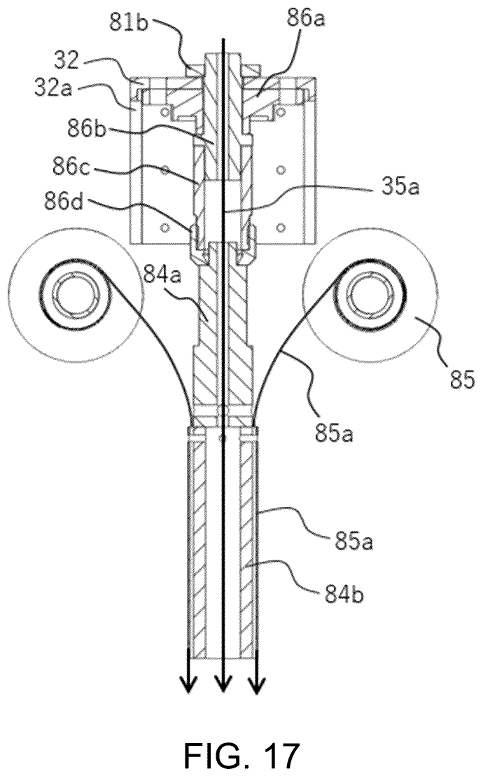

FIG. 17 is a sectional view of a device configuration example for transmitting a rotation force of the second gear 81b to the preform. A shaft part 86b, collets 86c and 86d, and the rotation tube 84a transmit the rotation force of the second gear 81b to the preform 35a. The shaft part 86b is a part that has a rotary shaft supported by a bearing 86a and is rotated in accordance with the rotation of the second gear 81b. The shaft part 86b can be produced by, for example, a 3D printing technology. The collets 86c and 86d connect the shaft part 86b and the rotation tube 84a. The rotation tube 84a is a part fixed to the collets 86c and 86d and the preform. The rotation tube 84a fixes and holds a part of the preform in the vertical direction, that is, the drawing direction. For example, a part of the preform can be manually fixed to the rotation tube 84a by a steel wire. In this case, work of fixing a new preform to the rotation tube 84a is required every time thermal drawing is performed. It is to be noted that, according to one example, a PEI (polyetherimide) piece can be used as the rotation tube 84a.

The fiber is manufactured from the preform receiving a force in any rotation direction by the rotation tube 84a and a tensile force by the rollers 38 and 39 while a part thereof is fixed in the up-down direction, that is, the drawing direction by the rotation tube 84a.

FIG. 17 shows the second supply device 85. The second supply device 85 is a roll that supplies a non-center material 85a such as a copper wire, for example. In this example, the heating tube 84b includes a center channel at the middle and a non-center channel on the outer side. In the center channel, the preform and the center material held by the rotation tube 84a are provided, and, in the non-center channel, the non-center material 85a is provided. The non-center material 85a can be directly provided to a non-center material channel of the heating tube 84b from the second supply device 85. In this example, with a capstan, that is, the rotations of the rollers 38 and 39 that draw the preform, all of the preform, the center material, and the non-center material are pulled downward to be drawn. This makes it possible to obtain a fiber in which the center material and the non-center material are formed integrally with the preform.

The center material and the non-center material are not particularly limited, and any materials are selected depending on the configuration of the fiber to be manufactured. For example, when the micro-coil fiber is to be manufactured, it is not always required to use a hard wire such as a copper wire, and a special alloy can be used. Further, a metal wire can be inserted in the preform in advance. In such a case, it is not required to provide the non-center material from the second supply device.

A method of manufacturing a fiber by the S-type thermal-drawing device 80 includes, for example, fixing a part of a preform to a rotation tube, and subjecting the preform to thermal drawing in a longitudinal direction while reciprocating the preform in a rotation direction by a rotation tube. The preform can be completed before the thermal drawing, or the thermal drawing may be performed without the preform being completed and with a material being supplied from the first supply device 83 and/or the second supply device 85. In the former case, the preform can be completed by forming a through hole in the base, or the preform can be completed by supplying a material such as a conductive wire to the through hole of the base. In the latter case, the thermal drawing is performed while a material is supplied to the through hole of the preform, the thermal drawing is performed while a material is supplied to the outer rim side of the preform, or the thermal drawing is performed while those materials are simultaneously supplied. The motion in the rotation direction to be applied to the preform may be any motion, and has high degree of freedom. For example, with the preform being subjected to thermal drawing while being reciprocated in the rotation direction at a non-uniform velocity, a fiber having a characteristic shape can be manufactured.

The S-type thermal-drawing device 80 exemplified in FIG. 14 can increase the speed of the reciprocating motion in the rotation direction of the preform with a new gear design. According to one example, the rotational motion of the motor is amplified by the first gear 81a and the second gear 81b and transmitted to the preform held by the rotation tube 84a. Increasing the speed of the motion of the preform in the rotation direction allows a fiber to be formed in a desired shape.

Moreover, in order to reflect the rotation force applied to the preform to the fiber shape at the fixing position of the preform, it is required to bring the fixing position of the preform close to the rollers 38 and 39 that are winding devices. In particular, when the preform is reciprocated at high speed in the rotation direction, in order to reflect a change caused by a change of direction to the fiber shape, it is required to bring the fixing position of the preform close to the rollers 38 and 39. In view of the above, in the S-type thermal-drawing device 80, a distance between the rotation tube 84a for fixing the preform and the rollers 38 and 39 that are the winding devices is shortened.

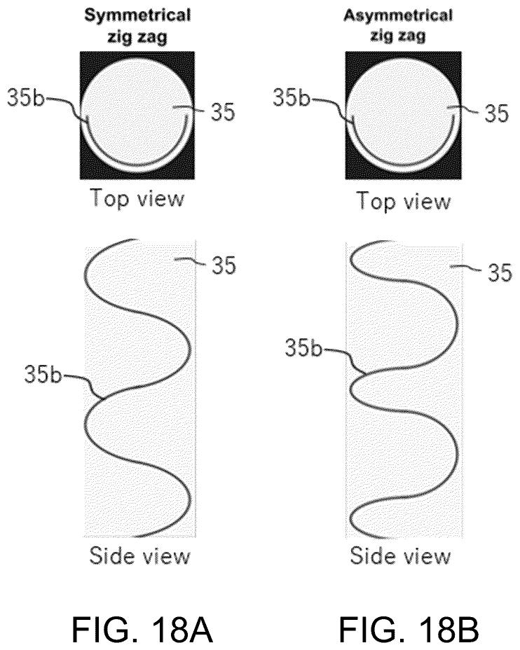

FIGS. 18A and 18B are views illustrating a configuration example of a fiber manufactured by the S-type thermal-drawing device 80. The fiber of FIGS. 18A and 18B is manufactured by subjecting the preform to thermal drawing while reciprocating the preform in the rotation direction.

An upper part of FIG. 18A shows a plan view of the fiber. The base of the fiber 35 is, for example, a polymer. A zigzag part 35b is formed in the base. This plan view is not a sectional view of the zigzag part 35b, but is a plan view of the entire zigzag part 35b with the base being expressed by white (transparent). Thus, the entire zigzag part 35b is formed only in a lower-half region of the fiber. A length of the zigzag part 35b in the circumference direction can be decided by adjusting the rotation of the second gear 81b. Thus, the zigzag part may be formed only in the lower-half region of the fiber as in this plan view, or an arc length of this zigzag part can be decreased or increased. The zigzag part 35b may be a flow channel or a conductive wire.

A lower part of FIG. 18A is a side view of the same fiber as the upper part. This side view shows an example in which the zigzag part 35b is formed at a constant period in the length direction of the fiber. That is, the zigzag part has a sine-wave shape. When the zigzag part 35b is a flow channel, for example, a hole may be formed in the longitudinal direction of the preform, and the preform may be subjected to thermal drawing while being reciprocated in the rotation direction by the S-type thermal-drawing device 80. In this case, no center material or non-center material is provided. When the zigzag part 35b is a conductive wire, for example, a hole may be formed in the longitudinal direction of the preform, and the conductive wire may be inserted in the hole. Then, the preform may be subjected to thermal drawing while being reciprocated in the rotation direction by the S-type thermal-drawing device 80.

FIG. 18B has many points similar to FIG. 18A, but the side view of the zigzag part 35b shows an example in which the zigzag part is formed at a non-constant period in the length direction of the fiber. As a result, it is possible to say that the zigzag part 35b of FIG. 18A is symmetrical in side view, and the zigzag part 35b of FIG. 18B is asymmetrical in side view. A short-period part of the zigzag part 35b of FIG. 18B can be formed by increasing the rotation speed of the preform, and a long-period part can be formed by decreasing the rotation speed of the preform. With the S-type thermal-drawing device 80, a force in the rotation direction to be applied to the preform can be freely adjusted, and hence the degree of freedom in the shape of the channel or the wire can be dramatically enhanced.

### Example 1

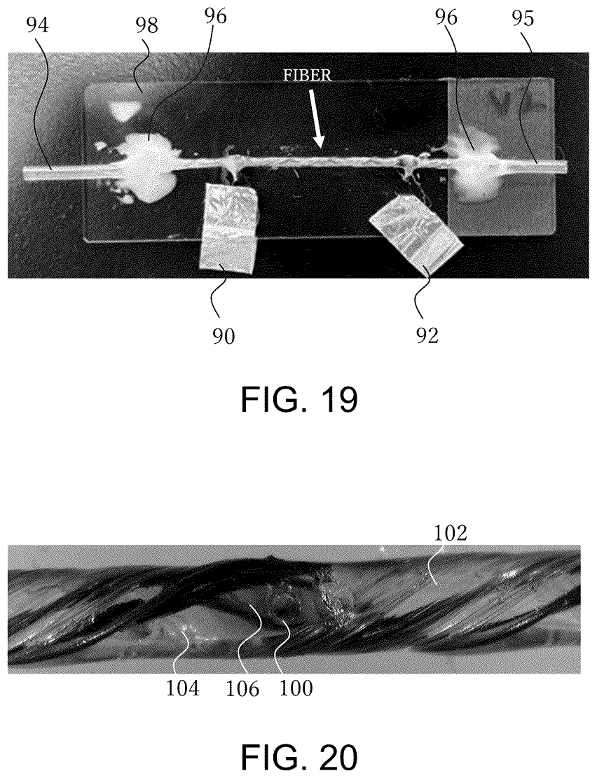

The fiber including the spiral electrodes illustrated in FIGS. 5 and 6 was processed to be formed as a device. FIG. 19 is a photograph of the created device. The tube of the fiber was partially ground and exposed, and electrodes 90 and 92 were attached to the two spiral electrodes. Moreover, silicone tubes 94 and 95 were connected to both ends of the tube of the fiber. After the tube and the silicone tubes were connected, those were fixed to a slide 98 with an adhesive 96. Agarose was dissolved in a buffer to prepare an agarose gel containing agarose of 1%, and this was introduced into the fiber. A hole for sample introduction was formed in the tube. A DNA loading dye of 0.1 μL was introduced into the microchannel from the formed hole. FIG. 20 is a photograph of a fiber having a sample introduced therein. The tube has an introduction port 100 formed for sample introduction. In this example, the introduction port 100 had a diameter of 100 μm. The DNA loading dye was introduced from this introduction port 100 into a microchannel 102. It can be observed from FIG. 20 that agarose 104 of 1% and a loading dye 106 are present in the microchannel 102. It was confirmed that, with a DC of 60 V being applied to the two spiral electrodes, the loading dye was subjected to electrophoresis in the microchannel. When the positive and negative poles of the voltage application were reversed, a state in which the loading dye was subjected to electrophoresis in the microchannel in an opposite direction was also confirmed.

### Example 2

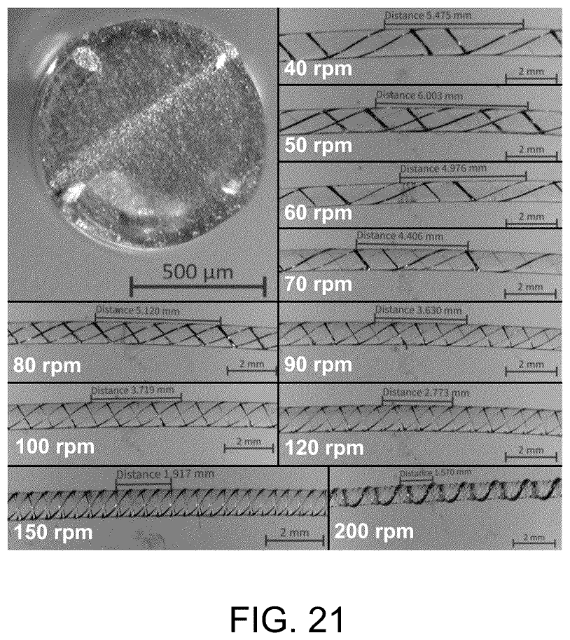

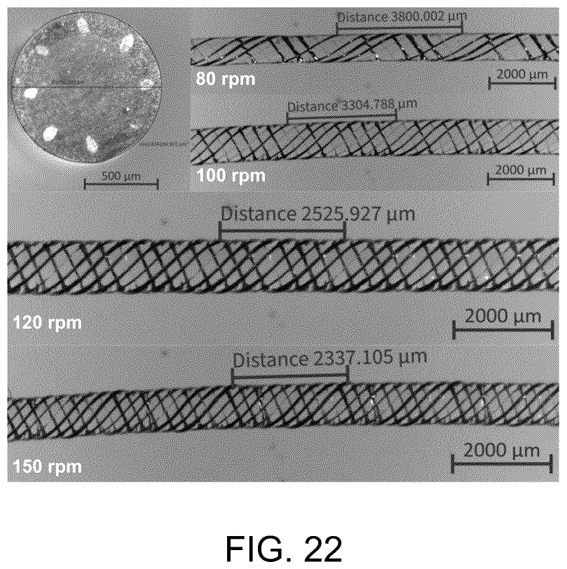

A micro-coil fiber was manufactured with the use of the rotation thermal-drawing device. FIG. 21 shows examples in which a plurality of preforms each prepared by inserting four conductor wires in the base were subjected to rotation thermal-drawing while changing the rotation speed. An upper left section of FIG. 21 shows a sectional view of the micro-coil fiber. A rotation speed at the time of rotation thermal-drawing is written at the lower left of each of the plurality of micro-coil fibers. It was confirmed from FIG. 21 that the pitch of the coil was able to be increased as the rotation speed was lower, and the pitch of the coil was able to be decreased as the rotation speed was higher. FIG. 22 shows examples in which a plurality of preforms each prepared by inserting eight conductor wires in the base were subjected to rotation thermal-drawing while changing the rotation speed. The upper left section of FIG. 22 shows a sectional view of the micro-coil fiber. Even in this case, it was confirmed that the pitch of the coil was able to be increased as the rotation speed was lower, and the pitch of the coil was able to be decreased as the rotation speed was higher. It is to be noted that, in all examples of FIGS. 21 and 22, the feed speed of preform was constant.

### Fourth Embodiment

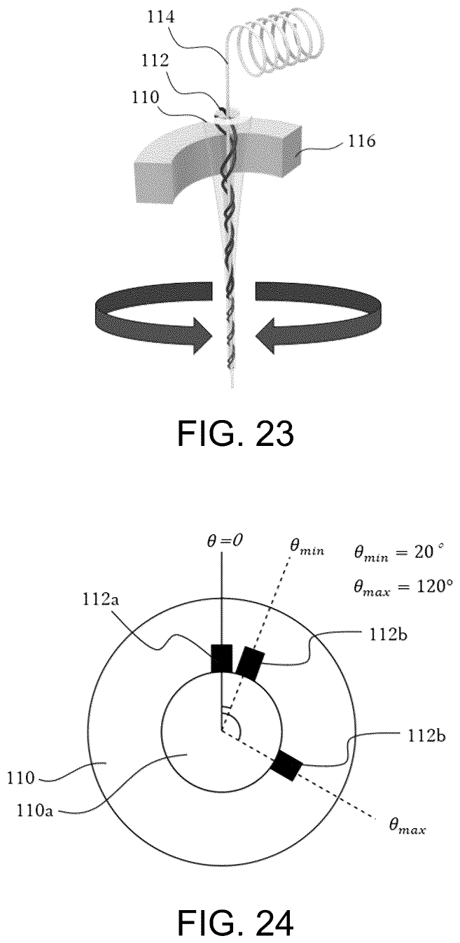

FIG. 23 is a view illustrating an example of a method of manufacturing a fiber according to a fourth embodiment. A preform includes a tubular base 110, a conductive wire 112, and a core material 114 provided in the base 110. The core material 114 can be, for example, a metal, an alloy, or a material having a certain level of hardness. Various technologies described above can be used for formation of the preform. The core material 114 in the present embodiment is, for example, a metal subjected to surface treatment with Teflon or a material that is soluble in any chemical solution. A fiber is formed by subjecting such a preform to thermal-drawing in one direction while moving the preform in the rotation direction. A heater 116 illustrated in FIG. 23 is simplified, and can be actually provided to surround the preform. While the preform is moved in a direction indicated by the arrows of FIG. 23, that is, the rotation direction, the preform is pulled downward by rollers or the like. According to one example, a fiber can be obtained by using the above-mentioned rotation thermal-drawing device or sweeping thermal-drawing device to create the preform of FIG. 23 and also rotate and thermally draw the preform. According to another example, the preform can be created in advance.

If the tubular base 110 is subjected to rotation thermal-drawing or sweeping thermal-drawing with the inside of the tubular base 110 remaining in a hollow state, the hollow may be closed, clogged, or deformed. Such a phenomenon is liable to occur as the speed in the rotation direction of the preform is faster and the inner diameter of the base is smaller. Further, the difference in material hardness between the base 110 and the conductive wire 112 also makes it difficult to maintain the shape of the hollow at the time of thermal-drawing. As a result, for example, the hollow shape that has been a circle in sectional view of the base 110 of FIG. 23 cannot be maintained in some cases.

However, according to the method of the present disclosure, the core material 114 is provided in the hollow part of the base 110, and hence the deformation of the shape of the preform during the thermal-drawing treatment can be suppressed. Provision of the core material 114 is particularly effective as the speed in the rotation direction of the preform is faster and the inner diameter of the base is smaller.

The core material 114 is removed from the fiber after the fiber is manufactured. According to one example, the core material 114 made of a metal subjected to surface treatment with Teflon can be pulled out from the fiber. When, for example, a thermoplastic polymer or a thermoplastic elastomer is used as the base 110, the core material from which a metal is exposed may adhere to the base 110. In view of the above, a material having a low friction coefficient such as Teflon is provided to the surface of the core material 114 to allow the core material 114 to be easily pulled out from the base 110. According to another example, a chemical solution is added to the fiber to melt the core material 114. As described above, it is possible to provide a fiber having a microchannel by removing the core material 114 from the fiber by pulling out or melting the core material 114.

With the use of the preform provided with the above-mentioned core material 114, even when the inner diameter of the tube (base) is as thin as, for example, 10 μm to 200 μm, thermal-drawing using the rotation thermal-drawing device or the sweeping thermal-drawing device is possible. A fiber having such a small inner diameter may be used in, for example, an electrophoresis device or the like.

FIG. 24 is a view illustrating an example of a sectional view of the fiber. The conductive wire includes a first conductive wire 112a, and a second conductive wire 112b separated from the first conductive wire 112a. The number of illustrated second conductive wires 112b is two, but any one thereof is actually provided depending on design. According to one example, in sectional view of the fiber, an angle formed between a straight line connecting the first conductive wire 112a and a middle of the hollow of the base 110 and a straight line connecting the second conductive wire 112b and the middle of the hollow of the base 110 can be set to 60° or less. A channel 110a has a diameter of, for example, 50 μm or less. When the fiber is used in electrophoresis, it is possible to generate a strong electric field by bringing the first conductive wire 112a and the second conductive wire 112b close to each other while providing a minute channel as described above. The level of closeness is expressed by an angle θ of FIG. 24. According to one example, it is possible to set the value of 0 to 120° or less, 60° or less, or 20° or less.

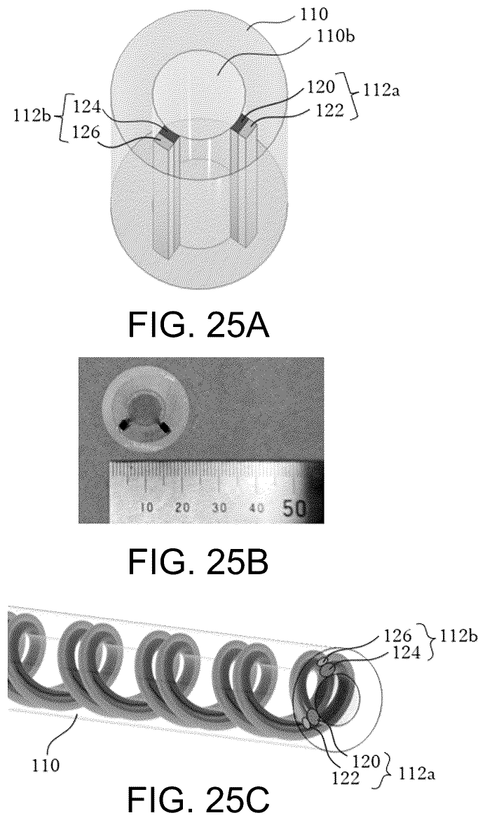

FIG. 25A is a view illustrating a creation example of the preform. The first conductive wire 112a includes a first electrode 120 exposed to a hollow 110b of the base 110, and a second electrode 122 that is in contact with the first electrode 120 and is not exposed to the hollow 110b. The second conductive wire 112b includes a first electrode 124 exposed to the hollow 110b of the base 110, and a second electrode 126 that is in contact with the first electrode 124 and is not exposed to the hollow 110b. The first electrodes 120 and 124 can be made of a material having higher chemical resistance than the second electrodes 122 and 126. Higher chemical resistance means low reactivity to any liquid such as an electrophoresis solution. According to one example, the first electrodes 120 and 124 are made of a CPE (carbon-based polyethylene) material or a material containing that, and the second electrodes 122 and 126 are made of a metal. FIG. 25B is a sectional photograph of the actually manufactured preform. This preform includes two conductive wires in each of which the CPE electrode and the metal electrode are brought into contact. An angle formed as defined above of the two conductive wires is about 90°. The CPE electrode is exposed to the hollow of the base, and the metal electrode is embedded in the base without being exposed to the hollow.

FIG. 25C is a view illustrating an example of a fiber formed from the preform of FIG. 25A. When the preform is subjected to thermal-drawing while being rotated by the rotation thermal-drawing device or the sweeping thermal-drawing device, the first conductive wire 112a and the second conductive wire 112b become spiral electrodes. FIG. 25C illustrates that the spiral electrodes include the first electrodes 120 and 124 exposed to the hollow of the tube and the second electrodes 122 and 126 that are in contact with the first electrodes 120 and 124 and are not exposed to the hollow. In this manner, liquid such as an electrophoresis solution provided in the hollow is brought into contact with the first electrodes 120 and 124 having higher chemical resistance, and hence the reaction of the spiral electrodes with the liquid such as the electrophoresis solution is suppressed. Moreover, with a metal part being included in the spiral electrode, efficient voltage application to the spiral electrode is possible.

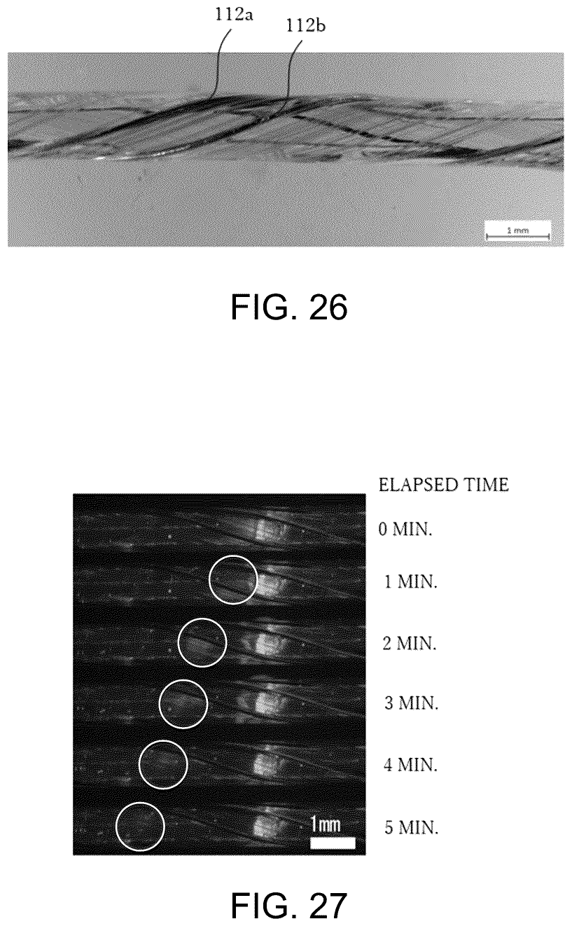

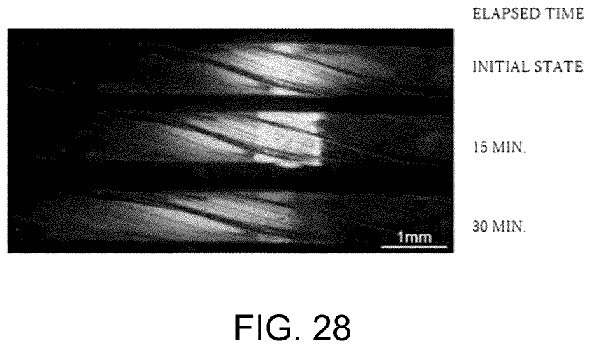

FIG. 26 is a photograph of an actually manufactured fiber. Two conductive wires each having a structure of a combination of the first electrode and the second electrode described above are provided. The first conductive wire 112a and the second conductive wire 112b are spiral electrodes. FIG. 27 is a photograph showing results of an electrophoresis experiment using the fiber of FIG. 26. In this experiment, for electrophoresis, agarose gel and 2 mL of TBE (Tris-borate-EDTA buffer) were used. In the channel, 1.2 μL of DNA, 0.2 μL of a buffer that was a tenfold diluted aqueous solution of 1×PBS (Phosphate-Buffered Saline), and 0.2 μL of SYBR Gold, which was a fluorescent dye, were provided. A DC voltage of 60 V was applied to the spiral electrodes. Photographs at 1-minute intervals from 1 to 5 minutes are shown in FIG. 27, and photographs at 15-minute intervals from 5 to 30 minutes are shown in FIG. 28. It was confirmed from those photographs that the electrophoresis experiment was possible by the manufactured fiber.

### Fifth Embodiment

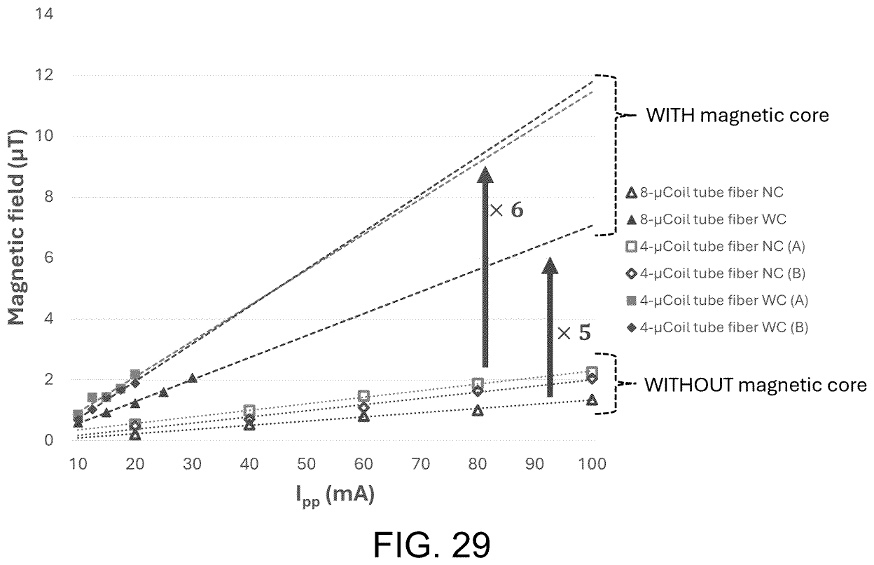

FIG. 29 is a graph summarizing magnetic fields generated by various micro-coil fibers. The relationship between the current caused to flow through the coil and the generated magnetic field strength was investigated for six micro-coil fibers. The six micro-coil fibers have the following specifications.
A fiber having 8 μCoils and including a hollow tube (unfilled triangle)
A fiber having 8 μCoils and including a tube provided with a bar magnet (filled triangle)
A fiber having 4 μCoils and including a hollow tube (unfilled square)
A fiber having 4 μCoils and including a hollow tube (unfilled rhombus)
A fiber having 4 μCoils and including a tube provided with a bar magnet (filled square)
A fiber having 4 μCoils and including a tube provided with a bar magnet (filled rhombus)

The fiber including the hollow tube is, for example, the micro-coil fiber 46 illustrated in FIG. 10A, and the fiber provided with the bar magnet is, for example, the micro-coil fiber 40 illustrated in FIG. 7.

For the fiber including the hollow tube, magnetic fields generated when currents of 20, 40, 60, 80, and 100 mA were caused to flow were investigated. Meanwhile, for the fiber provided with the bar magnet, magnetic fields generated when currents of 30 mA or less were caused to flow were investigated. In FIG. 29, a regression line obtained by linear regression analysis of the investigation results is indicated by the broken line. When the regression line is observed, it is understood that the fiber provided with the bar magnet is larger in the generated magnetic field than the fiber not provided with the bar magnet. In this example, in the case of the fiber having 8 μCoils corresponding to the triangle plot, with the provision of the bar magnet, a magnetic field that is approximately five times stronger than the fiber without the bar magnet can be generated. Further, in the case of the fiber having 4 μCoils corresponding to the square and rhombus plots, with the provision of the bar magnet, a magnetic field that is approximately six times stronger than the fiber without the bar magnet can be generated. Thus, with the bar magnet being incorporated, the generated magnetic field can be greatly increased.

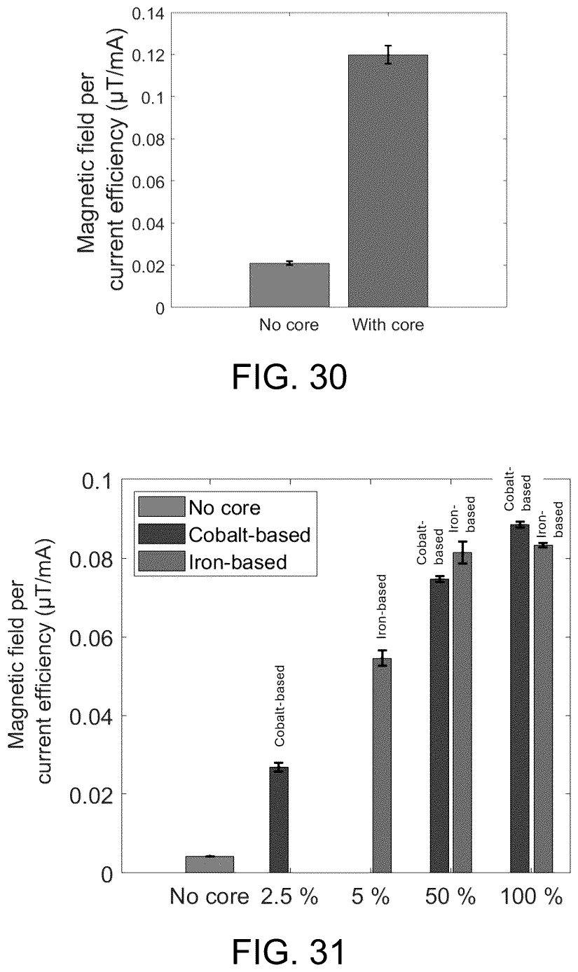

FIG. 30 is a diagram illustrating a magnetic field strength per unit current depending on presence or absence of a core, that is, the bar magnet. It is understood from this diagram that, with the bar magnet being provided, the magnetic field strength per unit current can be increased to be approximately six times stronger than the case in which the bar magnet is absent. That is, with the bar magnet being provided, the generated magnetic field efficiency can be enhanced.

FIG. 31 is a diagram illustrating a relationship between a hollow occupancy rate of the bar magnet and the magnetic field strength per unit current in the micro-coil fiber. The horizontal axis represents a percentage of the bar magnet occupying a sectional area of the hollow of the tube. “2.5%”, “5%”, and “50%” indicate that 2.5%, 5%, and 50% of the hollow of the tube are occupied by the bar magnet. At the time of “100%”, the entire hollow of the tube is occupied by the bar magnet. That is, no hollow is present and the inside of the tube is filled with the bar magnet. When FIG. 31 is observed, there is confirmed a tendency that the magnetic field strength per unit current can be increased as the occupancy rate of the bar magnet is increased. A great difference was not seen between a bar magnet containing cobalt as a main component and a bar magnet containing iron as a main component.

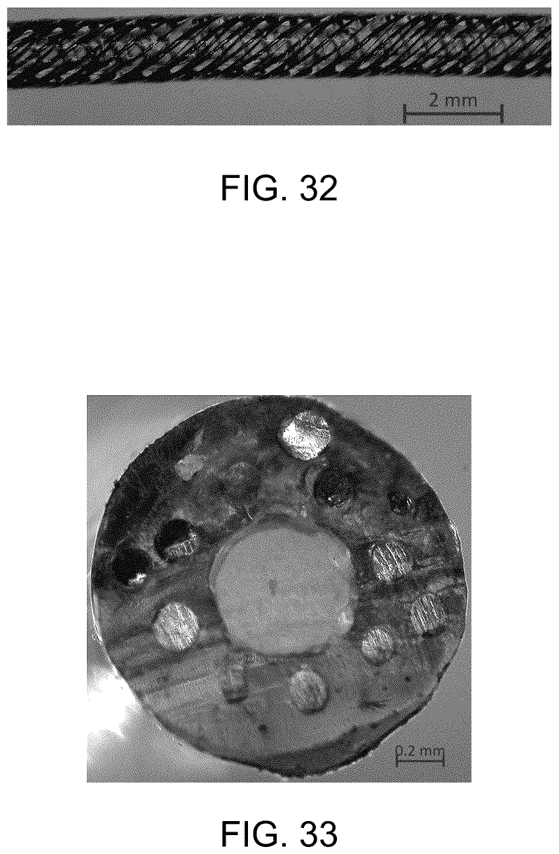

FIG. 32 is a plan view of the manufactured micro-coil fiber. In this micro-coil fiber with multi-layer structure, twelve coils are provided as spiral electrodes. The entire length of the micro-coil fiber is 20 cm. The number of turns of the spiral electrode is 40 per centimeter. The number of turns of the spiral electrode of the entire micro-coil fiber is 80.

FIG. 33 is a sectional view of the micro-coil fiber of FIG. 32. In a middle part of the tube, a bar magnet containing cobalt as a main component is provided. The coils are formed in a double concentric arrangement. Eight coils are annularly provided in an inner layer close to the bar magnet. Four coils are annularly provided in an outer layer on the outer side of the eight coils. As described above, in this micro-coil fiber, the coils have a multilayer structure. The micro-coil fiber of FIGS. 32 and 33 is one manufacturing example of the structure illustrated in FIG. 11 and described in the description for FIG. 11.

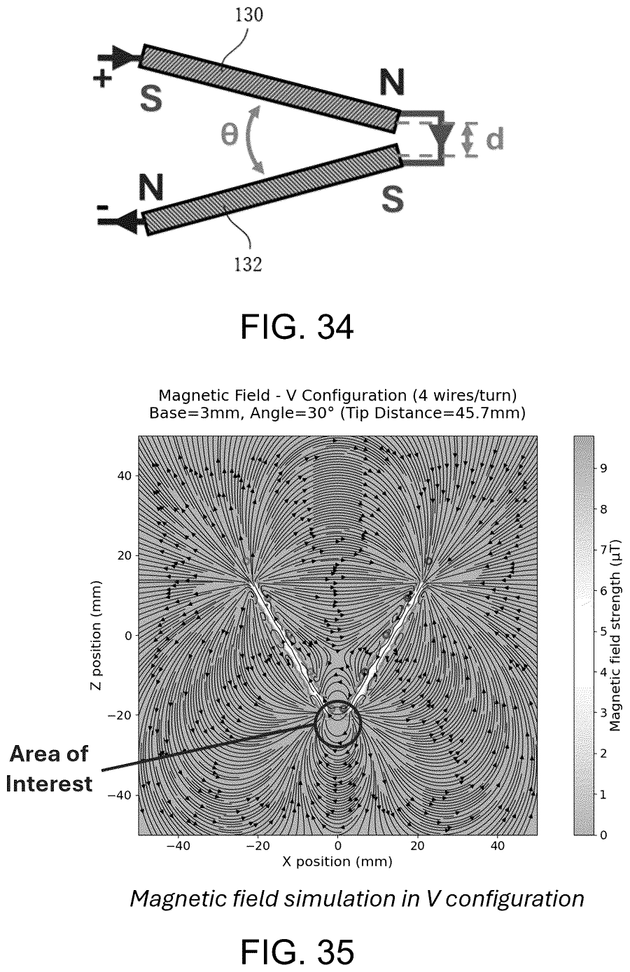

FIG. 34 is a view illustrating an example of an arrangement of a plurality of micro-coil fibers. A micro-coil fiber 130 and a micro-coil fiber 132 can each be any one of the micro-coil fibers described in the present embodiment or prior embodiments. FIG. 34 illustrates an example in which the micro-coil fibers 130 and 132 are arranged to form a V-shape. FIG. 34 illustrates an electrical connection relationship as well. With a distance d being adjusted or an angle θ being adjusted, the distribution and strength of the magnetic field can be adjusted. FIG. 35 is a diagram illustrating the V-shaped micro-coil fibers and magnetic field lines generated thereby. The magnetic field lines are created based on data obtained by calculation of a mathematical expression. The magnetic field is normally attenuated exponentially as separated away from a generation source, and hence it is expected that a strong magnetic field is obtained in a part of “Area of Interest”, that is, in the vicinity of distal ends of the micro-coil fibers. It is possible to determine the arrangement of the plurality of micro-coil fibers to obtain the maximum magnetic field at this “Area of Interest”. At this time, the micro-coil fiber of the present disclosure is suitable for downsizing and has a high degree of freedom in arrangement. In addition, the magnetic field strength can be increased by providing the bar magnet or the like, and hence a high magnetic field strength may be generated at a target portion. It is to be noted that, with reference to the result of FIG. 35, it is considered that the magnetic field strength is increased not at “Area of Interest” but at a position advancing therefrom in a minus z direction. This result suggests a possibility that a region having a high magnetic field strength can be provided not at the vicinity of the distal end of the micro-coil fiber but at a position ahead of the distal end.

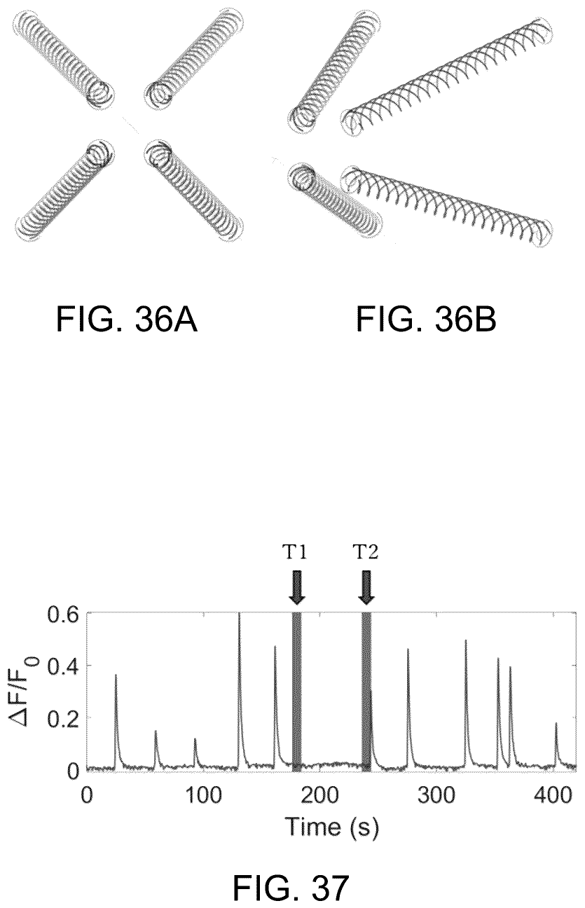

FIGS. 36A and 36B are diagrams illustrating an example of the arrangement of the plurality of micro-coil fibers. FIG. 36A illustrates an example in which a magnetic field at a predetermined position is adjusted with four micro-coil fibers. The predetermined position is, for example, a region including an intersection of two straight lines. FIG. 36B is a diagram of the same configuration as FIG. 36A as viewed from a different angle. In FIG. 36B, there is an intersection of two straight lines in one region on the left side of the four micro-coil fibers. The plurality of micro-coil fibers can be provided in a V-shape as in FIG. 34 or can be provided radially as in FIGS. 36A and 36B, or an arrangement different therefrom is also possible. For example, the number of micro-coil fibers can be five or more. Achieving an intended magnetic field in a specific portion by using the plurality of micro-coil fibers allows, for example, usage as non-invasive brain stimulation or usage as a magnetic sensing device. However, the application is not limited thereto, and various applications that require reduction in size, a strong magnetic field, or a degree of freedom of magnetic field adjustment can be assumed.

### Sixth Embodiment

The inventors have found that application of magnetic stimulation can affect the activity of nerve cells (cultured neuron). FIG. 37 is data related to the relationship between the magnetic stimulation and the cellular activity. The vertical axis represents an activity intensity (ΔF/F_{O}) of one nerve cell. The activity intensity is defined as a value obtained by dividing a fluorescence intensity change amount ΔF by a fluorescence intensity F_{O} in a steady state in which no activity is caused. This is also called a neural activity. The experiment of FIG. 37 was executed by providing synchronized nerve cells (that is, neuron with synchronized activities) to a neuron dish. Magnetic stimulation was applied to the nerve cells by using the micro-coil fiber of the present disclosure. A period from time T1 to time T2 is a period in which magnetic stimulation is applied to the nerve cells. It was observed that, during a period in which the magnetic stimulation was applied, the activity intensity (ΔF/F_{O}) was suppressed.

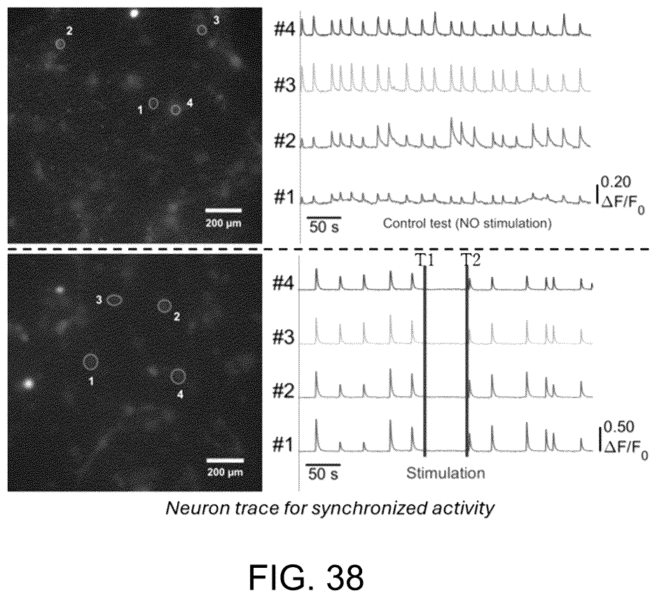

FIG. 38 is a diagram illustrating the influence caused by the magnetic stimulation to the neural activity. The photograph and the graph in the upper part are fluorescence and waveforms in a case in which no magnetic stimulation is applied to synchronized nerve cells. For example, a fluorescence experiment was performed by using fluorescence of cells caused when a calcium fluorescent reagent is taken into the cells when the cells are active. It was confirmed that, in four nerve cells 1 to 4, a certain neural activity was continued in a case of no magnetic stimulation.

Meanwhile, the photograph and the graph in the lower part of FIG. 38 are fluorescence and waveforms in a case in which magnetic stimulation is applied to synchronized nerve cells. It was confirmed that, in the four nerve cells 1 to 4, the activity was suppressed.

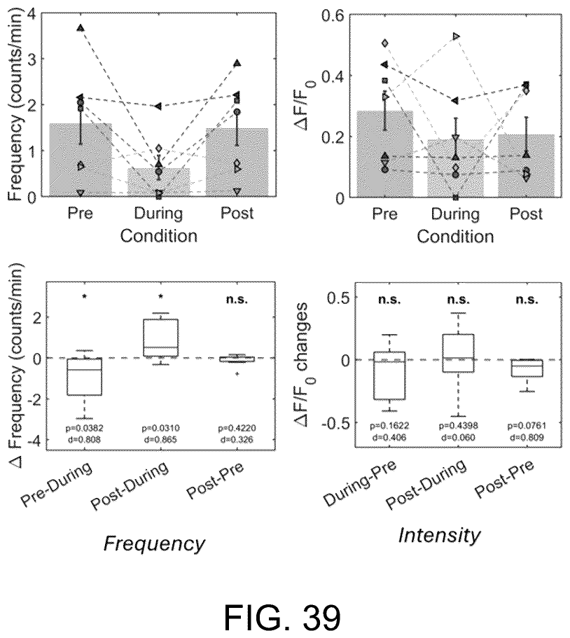

FIG. 39 is statistical data of the experiment performed with respect to the synchronized nerve cells. “Pre” is about before magnetic stimulation, “During” is about during magnetic stimulation, and “Post” is about after magnetic stimulation. The experiment was performed seven times in each stage, and those were plotted in two diagrams in the upper part. In the two diagrams in the upper part, the bar chart is a standard deviation of the mean. It is understood from the upper left diagram that, during the magnetic stimulation, the activity frequency of the nerve cells is suppressed as compared to that before or after the magnetic stimulation. The lower left diagram relates to “A Frequency” that is a change amount of the absolute value of the frequency. “Pre-During” represents a difference between “Pre” and “During”, “Post-During” represents a difference between “Post” and “During”, and “Post-Pre” represents a change amount between “Post” and “Pre”. The right diagram relates to a fluorescence intensity ΔF/F_{O}. It was statistically shown from those pieces of data that the activity in terms of frequency but not intensity of the synchronized nerve cells is suppressed by the magnetic stimulation.

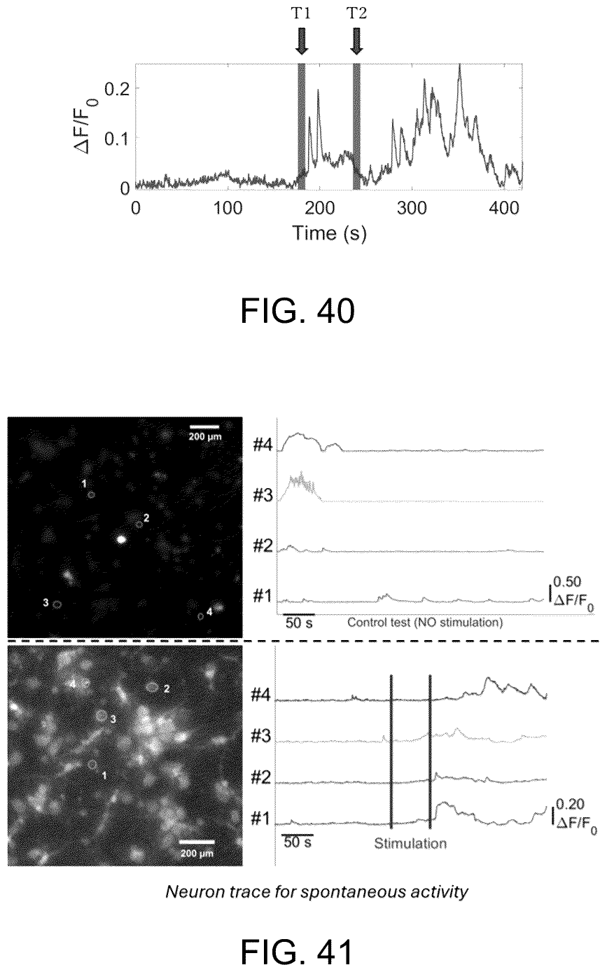

FIGS. 40 to 42 are views illustrating experiment results for spontaneously active nerve cells. The experiment method is similar to that described in FIGS. 37 to 39. The experiment of FIGS. 40 to 42 is different from the example of FIGS. 37 to 39 in that nerve cells that are not synchronized but are spontaneously active are used. FIG. 40 is a data relating to the relationship between the magnetic stimulation and the cellular activity. The experiment of FIG. 40 was executed by providing spontaneously active nerve cells (that is, neuron with spontaneous activities) to the neuron dish. Magnetic stimulation was applied to the nerve cells by using the micro-coil fiber of the present disclosure. A period from time T1 to time T2 is a period in which magnetic stimulation is applied to the nerve cells. It was observed that, after the period in which the magnetic stimulation was applied was ended, in a period thereafter, the activity intensity (ΔF/F_{O}) was increased.

FIG. 41 is a diagram illustrating the influence caused by the magnetic stimulation to the neural activity. The photograph and the graph in the upper part are fluorescence and waveforms in a case in which no magnetic stimulation is applied to spontaneously active nerve cells. It was confirmed that, in four nerve cells 1 to 4, a certain neural activity was continued in the case of no magnetic stimulation.

Meanwhile, the photograph and the graph in the lower part of FIG. 41 are fluorescence and waveforms in a case in which magnetic stimulation is applied to the spontaneously active nerve cells. In this case, it was confirmed that, in the four nerve cells 1 to 4, the activity was increased after the magnetic stimulation.

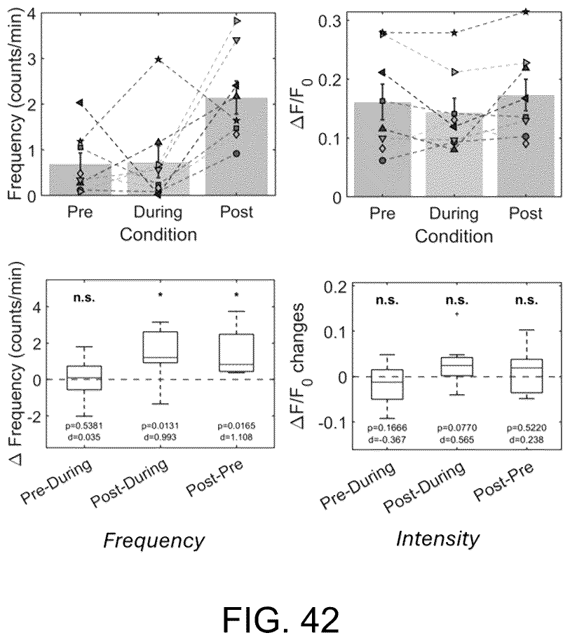

FIG. 42 is statistical data of an experiment with respect to the spontaneously active nerve cells. The experiment was performed eight times in each stage of “Pre”, “During”, and “Post”, and those are plotted in two diagrams in the upper part. It is understood from the two diagrams on the left side that, in “Post”, the activity frequency of the nerve cells is increased as compared to “Pre” and “During”. It was confirmed from two diagrams on the right side that the fluorescence intensity ΔF/F_{O} was substantially constant in any period.

As described above, it was confirmed that the activity of the synchronized cells was suppressed during the magnetic stimulation, and the spontaneously active cells became active after the magnetic stimulation.

### Seventh Embodiment

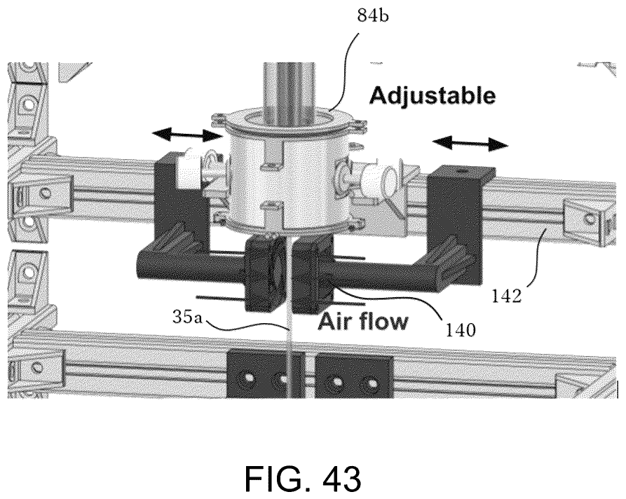

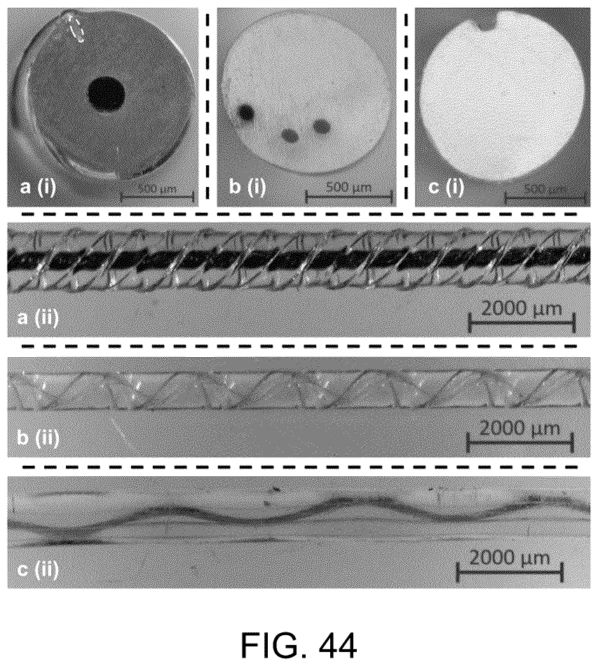

FIG. 43 is a view illustrating a part of a sweeping thermal-drawing device. Description of the sweeping thermal-drawing device is omitted here because the sweeping thermal-drawing device is already described with reference to FIG. 14 or the like. FIG. 43 illustrates a heating tube 84b and a preform 35a. The preform 35a right below the heating tube 84b is a part present above rollers (the same as the rollers 38 and 39 of FIG. 14) that draw the preform downward. An air flow device 140 that supplies air flow is provided at a position between the heating tube 84b and the two rollers. In the example of FIG. 43, two air flow devices 140 are provided to sandwich the preform. According to another example, three or more air flow devices can be provided so as to surround the preform. According to one example, the air flow device 140 is fixed in a slidable manner to a bar 142. This makes it possible to slide the air flow device 140 along the bar 142 to bring the air flow device 140 close to or away from the preform in the example of FIG. 43.

The preform may be increased in temperature when passing through the heating tube, and the fluidity may be increased. In particular, when elastomer or metal is used as the material of the preform, the fluidity is increased by heating. When the fluidity of the preform is increased, the preform may be crushed, a force applied to the preform for rotation or drawing may not be sufficiently applied, or the shape of the preform may be deformed. This problem becomes particularly apparent in a small-sized thermal-drawing device. In order to suppress this, the preform that has passed through the heating tube is promptly cooled by the air flow device 140 to be recovered to a certain level of hardness. Cooling the preform from a plurality of directions allows the preform to be uniformly cooled with good balance.

### Eighth Embodiment

FIG. 44 shows six photographs of three fibers. Pictures 44(a)(i), 44(b)(i), and 44(c)(i) are cross-sectional views, and the respective top views are pictures 44(a)(ii), 44(b)(ii), and 44(c)(ii). These fibers were formed by the sweeping thermal-drawing device. The fiber in Pictures a(i) and a(ii) includes a central core material positioned in the center of the base in a cross-sectional view, and a spiral conductive wire wound around the base. The fiber in Pictures b(i) and b(ii) includes three spiral conductive wires. These conductive wires have dense portions and sparse portions by being formed with a non-uniform period in the length direction of the fiber. The fiber in Picture c(i) shows a surface groove formed on the surface of the base. A flow channel or a conductive wire can be provided in this surface groove. According to another examples, a plurality of surface grooves can be formed. Picture c(ii) shows a conductive wire installed in the surface groove. In one example, this conductive wire is provided as a zigzag portion.

This application claims the benefit of Japanese Patent Application No. 2024-198881, filed Nov. 14, 2024, which is hereby incorporated by reference herein in its entirety.

1. An electrophoresis device comprising:
a tube having an introduction port for a sample, formed therein, the tube having an inner diameter of 200 μm or less;
at least two spiral electrodes provided in the tube; and
a power supply device that applies a voltage to the spiral electrodes.

2. The electrophoresis device according to claim 1, wherein:
the tube includes a thermoplastic polymer or a thermoplastic elastomer; and
the spiral electrodes include a carbon composite material or chemically inert conductor.

3. The electrophoresis device according to claim 1, wherein each of the spiral electrodes includes a first electrode exposed to a hollow of the tube, and a second electrode that is in contact with the first electrode and is not exposed to the hollow, and the first electrode has a higher chemical resistance than the second electrode.

4. The electrophoresis device according to claim 3, wherein the first electrode includes a CPE material, and the second electrode is a metal.

5. A micro-coil fiber comprising:
a tube;
one micro-coil obtained by combining a plurality of coils having the same pitch and each having an inner diameter of 500 μm or less, the one micro-coil having at least a part embedded in the tube; and
a bar magnet or magnetic particles provided in a flow channel of the tube.

6. The micro-coil fiber according to claim 5, wherein:
the magnetic particles are provided in the flow channel of the tube;
the micro-coil fiber further comprises a porous material provided in the flow channel of the tube; and
the magnetic particles are provided in pores of the porous material.

7. The micro-coil fiber according to claim 5, further comprising:
an additional tube that covers an outer rim of the tube; and
one additional micro-coil obtained by combining a plurality of coils having the same pitch, at least a part of the one additional micro-coil being embedded in the additional tube.

8. A sweeping thermal-drawing device comprising:
a first gear to be rotated by a motor;
a second gear to be rotated in conjunction with the first gear;
a rotation tube to be in conjunction with rotation of the second gear;
a heating tube positioned below the rotation tube, the heating tube being capable of performing heating treatment; and
two rollers provided below the heating tube,
wherein the second gear, the rotation tube, the heating tube, and the rollers are arranged on one straight line in a vertical direction.

9. The sweeping thermal-drawing device according to claim 8, further comprising a first supply device that supplies a material into the rotation tube through a through hole of the second gear.

10. The sweeping thermal-drawing device according to claim 8, further comprising a second supply device that supplies a material to the heating tube.

11. The sweeping thermal-drawing device according to claim 8, further comprising an air flow device that supplies air flow at a position between the heating tube and the two rollers.
